(19) United States
(12) Patent Application Publication
(10) Pub. No.: US 2025/0298169 A1
(43) Pub. Date: Sep. 25, 2025

(54) METALENS WITH SILICON-RICH SILICON NITRIDE

(71) Applicant: The Regents of the University of Michigan, Ann Arbor, MI (US)

(72) Inventor: Ya Sha YI, Troy, MI (US)

(21) Appl. No.: 19/090,321

(22) Filed: Mar. 25, 2025

Related U.S. Application Data
(60) Provisional application No. 63/569,494, filed on Mar. 25, 2024.

(51) Int. Cl. G02B 1/00; C01B 21/068

(52) U.S. Cl. CPC G02B 1/002; C01B 21/068; C01P 2002/84; C01P 2004/03; C01P 2006/60

(57) ABSTRACT

A subwavelength metalens includes a layer of silicon nitride having a refractive index greater than 2.0. The refractive index may be tailored to be within a range from 2.0 to 3.2 based on parameters of a vapor deposition process in which reactive gases are introduced into the deposition chamber in a ratio that forms silicon nitride in which the ratio of silicon to nitrogen is greater than that of Si₃N₄. These high refractive index materials enable reduction of a pitch size within which phase shifters of the lens are formed without increasing the thickness of the material relative to conventional metalens materials such as TiO₂ or GaN.

This invention was made with government support under 1428069 awarded by the National Science Foundation. The government has certain rights in the invention.

### BACKGROUND

Conventional optical lenses are made from transparent materials such as glass through mechanical processes such as grinding. The performance of such a lens is mainly limited by mechanical error such that a perfect convex or concave surface is unattainable. Recent advances in CMOS compatible nanofabrication techniques has enabled the fabrication of high aspect ratio nanostructures with transparent materials. This has given rise to the development of metasurface lenses, also referred to as metalenses. A metasurface can be formed from nanostructures that are smaller than the wavelength of visible light. Through this approach, numerous types of bulk optical elements can be replaced by a thin layer of nanostructures with similar or even better performance. Furthermore, with full control of phase, transmission, and polarization of wavefronts, a metasurface can enable integration of multiple functionalities including achromatic focusing, color routing, and multispectral chiral imaging into one lens. Because such lenses rely on a thin layer of nanostructures, they have inherent advantages in that they are compact and lightweight. Compared with traditional planar optical devices including Fresnel lenses or Fresnel zone plates, metalenses provide better performance in various aspects-especially efficiency. This is mainly realized by the ability to engineer the surface with sub-visible wavelength precision.

### SUMMARY

Embodiments of a subwavelength metalens include a layer of silicon-rich silicon nitride in which a ratio of silicon to nitrogen is greater than 0.75.

Embodiments of a subwavelength metalens include an optically transparent substrate and a plurality of discrete phase shifters disposed over the substrate. Each phase shifter is located within a respective discrete period of an array of periods defined over the substrate. Each period has a planar dimension less than or equal to 280 nm, each phase shifter has a dimension in a first direction equal to the planar dimension of the respective period such that the phase shifters are continuous in the first direction, each phase shifter has a dimension in a second direction perpendicular to the first direction in a range from 10% to 90% of the planar dimension of the respective period such that a fill factor of the plurality of periods varies as a function of distance from a center of the metalens in the second direction, and the phase shifters are formed as a layer of silicon-rich silicon nitride having a ratio of silicon to nitrogen greater than 0.75.

The metalens may include one or more of the following features in any technically feasible combination:
the silicon-rich silicon nitride has a refractive index in a range from 2.0 to 3.2 at a visible wavelength,
the silicon-rich silicon nitride has a refractive index in a range from 2.1 to 2.8 at a visible wavelength,
the silicon-rich silicon nitride has a refractive index in a range from 2.7 to 2.8 at a visible wavelength,
the silicon-rich silicon nitride has a refractive index of 2.74 at a 685 nm wavelength,
the layer of silicon-rich silicon nitride includes a plurality of discrete phase shifters each arranged in a discrete period of the layer,
each period of the layer of silicon-rich silicon nitride has a planar dimension less than 350 nm,
each period of the layer of silicon-rich silicon nitride has a planar dimension of 220 nm,
each phase shifter of the layer of silicon-rich silicon nitride has a planar dimension less than 220 nm,
at least one phase shifter of the layer of silicon-rich silicon nitride has a planar dimension of 60 nm,
at least one other phase shifter of the layer of silicon-rich silicon nitride has a planar dimension greater than 60 nm and less than 220 nm,
phase shifters of the layer of silicon-rich silicon nitride are in the form of concentric rings,
phase shifters of the layer of silicon-rich silicon nitride are arranged in an orthogonal array of periods,
a fill factor for each period of the layer of silicon-rich silicon nitride is 100% in a first direction and varies in a range from 10% to 90% is a second direction that is perpendicular to the first direction,
phase shifters of the layer of silicon-rich silicon nitride are arranged in concentric bands in which a fill factor of the periods within the band decreases with distance from a center of the metalens,
the layer of silicon-rich silicon nitride lens has a thickness of 600 nm or less and the lens has full 2π phase coverage with a period less than 350 nm, or
the metalens is substantially free from titanium oxide and gallium nitride.

Embodiments of a method of making any of the above-listed metalenses include plasma-enhanced chemical vapor deposition of the silicon-rich silicon nitride onto a substrate. The refractive index of the silicon-rich silicon nitride may be a continuous function of a ratio of silane and ammonium in a gas mixture introduced into a deposition chamber.

### BRIEF DESCRIPTION OF THE DRAWINGS

FIG. 1 schematically illustrates a cross-section of an example of a metalens in a two-dimensional domain.

FIG. 2 schematically illustrates a cross-section of an example of a metalens in a two-dimensional domain, where the period P is smaller than that of the metalens of FIG. 1.

FIG. 3 is an SEM image obtained at a central region of a grating-based metalens fabricated with CMOS-compatible nanofabrication techniques.

FIG. 4 is a plot of refractive index as a function of wavelength for various sputtered SiNx films.

FIG. 5 is a plot of extinction coefficient as a function of wavelength for the SiNx films of FIG. 4.

FIG. 6 is a plot of refractive index as a function of wavelength for various PECVD SiNx films.

FIG. 7 is a plot of extinction coefficient as a function of wavelength for the SiNx films of FIG. 4.

FIG. 8 is an RCWA simulation of phase distribution for phase shifters of a particular pitch, thickness, and feature size at two different refractive indexes.

FIG. 9 is a plot of focus efficiency as a function of pitch size.

FIG. 10 illustrates the field distribution of lenses designed with a 220 nm period.

FIG. 11 illustrates the field distribution of lenses designed with a 360 nm period.

FIG. 12 is a schematic cross-sectional depiction of the fabrication of the metalens of FIG. 3.

FIG. 13 is a schematic view of a laser-based optical system 100 for characterizing a metalens.

FIG. 14 depicts the characterized field distribution of a meta lens at the plane of focus.

FIG. 15 depicts a focus profile plot for a metalens.

FIG. 16 is a plan view of a metalens configured to achieve a linear polarization distinguishing effect.

### DESCRIPTION OF EMBODIMENTS

Generally, a metalens is an optically transparent substrate with a metasurface formed thereon. A metasurface may include or be constructed from an arrangement of sub-visible wavelength (i.e., less than 380 nm) phase shifters defined by nanostructures in a space-variant phase profile. This profile may be described by equation (1) in a two-dimensional domain, and by equation (2) in a three-dimensional domain, assuming the lens is laid out along an x-y plane:

$$ϕ ( x ) - ϕ ( 0 ) = \frac{2 π}{λ} ( \sqrt{{x}^{2} + {f}^{2}} - f ) \qquad ( 1 )$$

$$ϕ ( x , y ) - ϕ ( 0 , 0 ) = \frac{2 π}{λ} ( \sqrt{{x}^{2} + {y}^{2} + {f}^{2}} - f ) , \qquad ( 2 )$$

where λ is the incident wavelength, f is the designed focal length, x and y are respective distances between the phase shifter and the center of the lens, ϕ(x) and ϕ(x, y) are the desired phase for the phase shifter, and ϕ(0) and ϕ(0,0) are the phase shifted at the center of lens.

In order to achieve the aforementioned phase profile, a lens plane may first be discretized into a finite number of periods. Then, high-refractive index materials can be filled into each period with a designed geometry, which provides variation in the effective index over the lens plane. The objective is to achieve the engineering of optical response within each period, including transmission and phase shift. The engineering of phase shift by nanostructures may be the most important process for metalens design.

Conventionally, in order to achieve 2π phase coverage, the metasurface is formed from high-refractive index materials such as titanium dioxide (TiO₂) and gallium nitride (GaN) with aspect ratios greater than 10. However, the deposition processes required for these materials is typically atomic layer deposition (ALD) or metal-organic chemical vapor deposition (MOCVD), which have increased the time and cost of nanofabrication to a large extent.

One approach to maximizing the performance of a metalens is to shrink the pitch size or period. This can help avoid the influence on wavefront caused by the discretization of space so that the loss caused by scattering or unwanted resonance is minimized. However, decreasing pitch size in pursuit of higher focus efficiency is limited by a trade-off between phase coverage and the limitations of nanofabrication. To be specific, the smallest feature size of each phase shifter is limited by current nanofabrication techniques. As such, there exists a threshold period or pitch size for particular material and incident wavelength combinations below which sufficient phase coverage cannot be achieved.

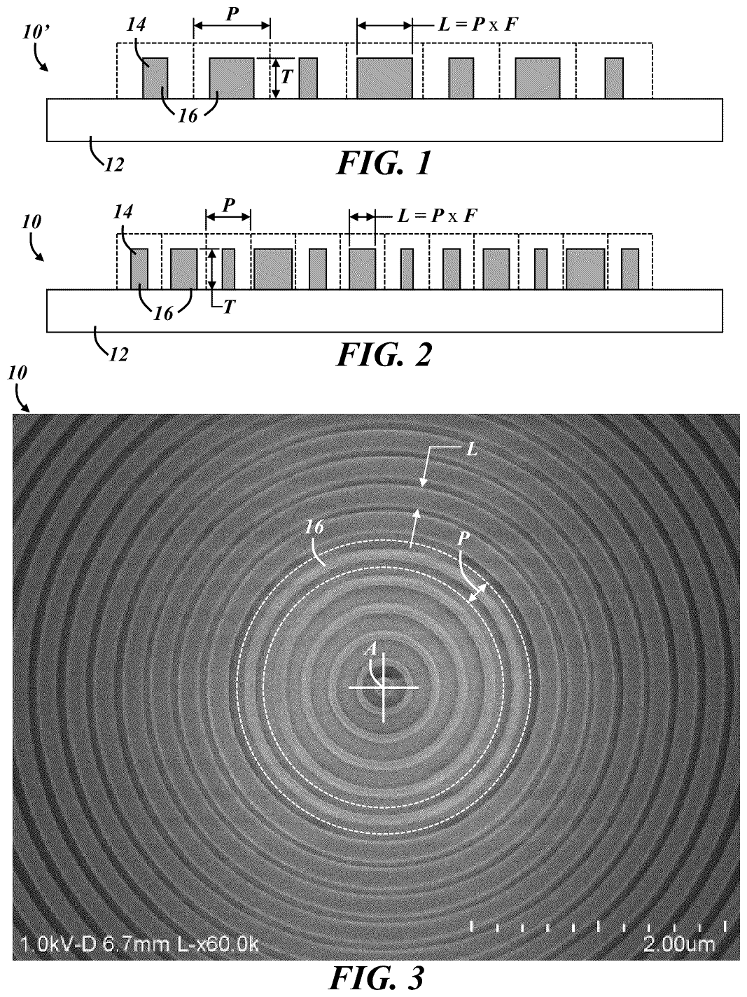

FIGS. 1 and 2 schematically illustrate cross-sections of examples of respective metalenses 10′ and 10 in a two-dimensional domain. Each lens 10′, 10 includes an optically transparent substrate 12 (e.g., glass) and a layer of lens material 14. The lens material 14 is a metamaterial composed of nanostructures arranged in discrete portions referred to as phase shifters 16. As used herein, a nanostructure is a unit of material having at least one dimension less than or equal to 500 nm. As applied to metalenses, nanostructures having at least one dimension less than 380 nm, which is the smallest wavelength of visible light, may be of particular interest. Each phase shifter 16 is located within an individual region along the lens surface defined according to a period or pitch distance P. The period P may be uniform across the planar extent of the lens. The lens 10′ of FIG. 1 is depicted with a relatively large period P, consistent with conventional metalens materials such as TiO₂ or GaN, and the lens 10 of FIG. 2 is depicted with a relatively small period P, consistent with the new metalens materials disclosed herein.

A fill factor F for each period P is defined as the fraction of each period P occupied by the respective phase shifter 16, which is a planar dimension of the phase shifter divided by the period P. In the 2D examples of FIGS. 1 and 2, the fill factor F for each period is F=L/P. The fill factor F may be in a range from 10% to 90%, although current nanofabrication methods may place practical limits on the fill factor. For instance, where nanofabrication limits feature sizes to a maximum value Lmax, the associated fill factor for a given period P may be in a range from Lₘₐₓ/P to P−Lₘₐₓ/P. In a three-dimensional domain, the fill factor for each period is F=A/PA, where A is the planar area of the phase shifter 16 and PA is the planar area of the period. The lens material 14 and each phase shifter 16 are also characterized by a thickness T, measured in a direction perpendicular to a surface of the substrate 12 on which the lens material 14 is arranged. Each nanostructure and/or phase shifter 16 has an aspect ratio defined by T/L.

FIG. 3 is an SEM image obtained at a central region of a grating-based metalens 10 fabricated with CMOS-compatible nanofabrication techniques. The lens 10 was designed with numerical aperture NA=0.65 by rotating a 2D phase profile about an axis A and has a diameter of 40 μm. The pictured region is about 5×5 μm. In this example, each phase shifter 16 is in the form of a ring, and the period P is 220 nm. The smallest feature size L of each ring 16 is in a range from about 60 nm to about 180 nm, with associated fill factors ranging from about 25% to about 80%.

The smallest possible period P is limited by feature size—i.e., the smallest feature size L within the limits of nanofabrication. As noted above, one approach to increase the efficiency of a metalens is to minimize the influence of space discretization—i.e., to shrink the pitch size within which each phase shifter 16 is located. Theoretically, phase coverage of a metalens is increased with increased refractive index and thickness T of the lens material 14. Based on current nanofabrication techniques, the dimensions of the phase shifters 16 are limited to certain feature size and thickness combinations—i.e., a maximum-achievable aspect ratio T/L. The pitch size P for a conventional TiO₂-based metalens is 350 nm with a thickness T of 600 nm. This pitch size P is near the limit (i.e., near the smallest-possible pitch size) for a material with n=2.4 to cover a 2π phase shift. That is, even if nanofabrication limitations would permit a smaller pitch size P, the refractive index of TiO₂ is not high enough to cover a 2π phase shift with such dimensions.

The metalens 10 of FIG. 3 achieves a 2π phase shift with a pitch size P that is drastically reduced compared to conventional metalens materials via use of a novel silicon nitride material as the lens material 14. Typical silicon nitride, Si₃N₄, has a refractive index of about n=2.0 and does not address the problematic loss of phase shift range associated with reducing the feature size of conventional materials like TiO₂. New techniques have been developed to form metalenses from silicon nitride that is rich in silicon (Si)—i.e., silicon nitride in which the ratio of Si to N is greater than 0.75, resulting in refractive indexes as high as n=3.2. This family of silicon nitrides may be denoted SiNx, where x is variable and represents the ratio of nitrogen to silicon in the bulk material—e.g., Si₃N₄ may be written as SiN_{1.33}. SiNx can be deposited with more cost-efficient thin film deposition processes than TiO₂ or GaN, such as physical vapor deposition (PVD) or plasma-enhanced chemical vapor deposition (PECVD). In one example, an SiNx film has a relatively high refractive index of n=2.74 at a targeting wavelength of 685 nm. As described further below, a metalens has been designed, fabricated, and characterized for proof of concept.

Silicon nitride (Si₃N₄) is conventionally used as a passivation layer in the CMOS fabrication industry. Recent advances in optical communication have seen Si₃N₄ used in waveguide applications. Si₃N₄ has a refractive index of approximately n=2.0 in the visible part of the spectrum. In a metalens application, this requires nanostructures with a relatively high thickness for 2π phase coverage. As limited by current nanofabrication techniques, this has resulted in a large pitch size such that the negative impact on focus efficiency is unacceptable. The common upper limit for pitch size is below the Abby's diffraction limit

$$( \frac{λ}{2 NA} )$$

if the lens is targeting on diffraction-limited focus. As a result, a smaller pitch size with 2π coverage becomes a must such that a higher refractive index is essentially required.

Formation of a silicon-rich SiNx material is not as simple as increasing the amount of silicon or decreasing the amount of nitrogen in the target material used in a conventional silicon nitride PVD deposition process. In particular, conventional PVD fabrication of a silicon nitride thin film involves magnetron sputtering of a pure Si₃N₄ target, making it impossible to enrich the deposited film with silicon.

Embodiments of a new method of fabricating silicon-rich, high refractive index SiNx films include use of a reactive magnetron sputtering process and/or use of a reactive plasma-enhanced chemical vapor deposition (PECVD) process. In one example, the method may include magnetron sputtering of a silicon target material in a nitrogen-containing atmosphere. For example, the silicon target material may be sputtered onto a substrate surface in a chamber in which a mixture of nitrogen (N₂) and an inert gas (e.g., argon) are flowing.

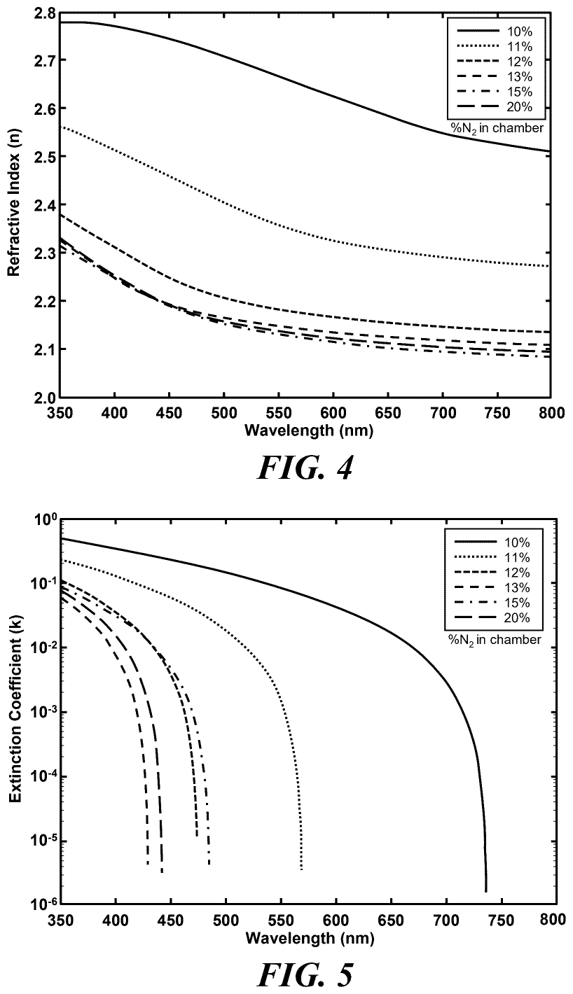

FIGS. 4 and 5 chart the respective refractive indexes (n) and extinction coefficients (k) as a function of wavelength for various SiNx films produced using a reactive sputtering method with nitrogen concentrations ranging from 10% to 20%. A silicon target (Kurt J. Lesker Company) was used in a Lesker PVD 75 DC sputtering tool with the power fixed at 350 Watts. A radio-frequency bias power of 60 W was applied on the deposition substrate. The pressure of the process chamber was fixed at 6 mT with N₂ and Ar gas flowing simultaneously. All films were deposited with a thickness around 200 nm and their optical parameters n, k were measured via ellipsometer (Woollam M-2000).

As shown in FIG. 4, the film produced in an environment of 10% N₂/Ar ratio provides a refractive index n>2.5 through all visible bandwidths. That film also had a significant absorption for light below 738 nm, as shown in FIG. 5. When the N₂/Ar ratio is increased to 11%, the refractive index drops significantly from about 2.6 to below 2.4 (at 685 nm, for example). This film has a refractive index comparable with TiO₂ and GaN but with a relatively large absorption below 570 nm (FIG. 5). The refractive index experiences another step decrease for films produced with an N₂/Ar ratio higher than 11%. As a result, it is suitable for a metalens targeting wavelength above 570 nm.

In other embodiments, the method includes plasma-enhanced chemical vapor deposition (PECVD) of SiNx films. The reaction gases may include silane (SiH₄) and ammonia (NH₃), which can produce SiNx film at a temperature under 350° C. Here again, the refractive index of the film can be tuned by the varying the relative gas concentrations, but with a larger processing window than the reactive sputtering process.

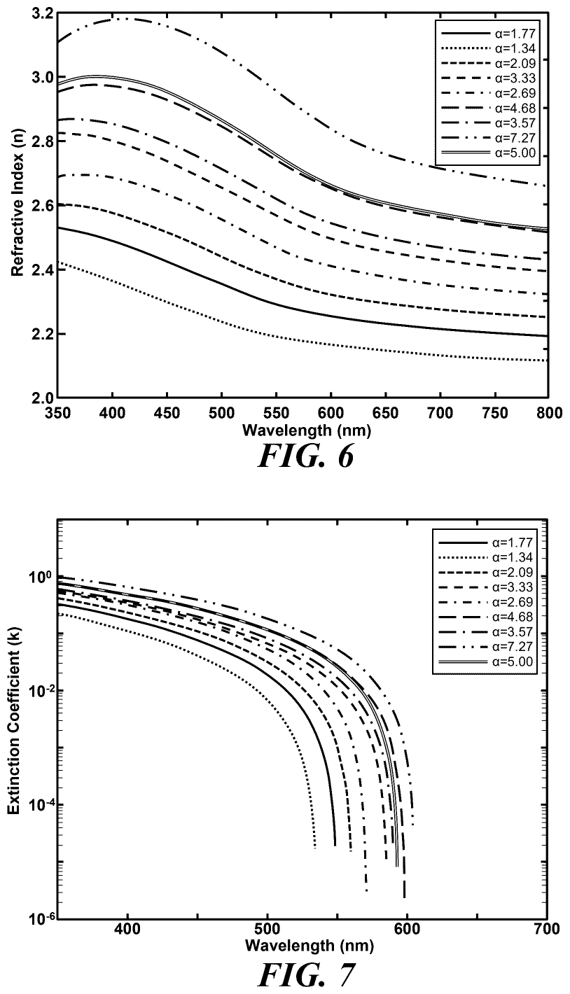

FIGS. 6 and 7 chart the respective refractive indexes (n) and extinction coefficients (k) as a function of wavelength for various SiNx films produced using this method, where α is the ratio of silane to ammonia in the CVD chamber and chamber pressure is fixed at 2 torr. As observed in FIG. 6, the PECVD process demonstrates better control of refractive index through the variation of gas concentration—that is, a larger change in the gas mixture is required to effect a change in refractive index of the deposited film. For example, at 685 nm, the refractive index can be tuned continuously between 2.1 to 2.7 with gas ratios from 1.3 to 7.3 or, inversely, 14% to 77%. As shown in FIG. 7, the cut-off wavelength with extinction coefficient above zero ranges from about 530 nm to 600 nm.

The selection of refractive index may be based on targeting wavelength with consideration of two aspects: 2π phase coverage and phase control as limited by fabrication precision. For phase shifters, a higher refractive index lowers the aspect ratio needed for 2π coverage, while it increases the degree of precision required in fabrication. The disclosed PECVD process with continuous tuning of refractive index provides excellent balancing of these two factors based on targeting wavelengths. Among the illustrated PECVD-produced examples of SiNx films, the film deposited with a SiH₄/NH₃ ratio of α=4.68 provides a suitable balance with a high refractive index at 685 nm and with k=0 above 600 nm. As a result, this type of silicon-rich SiNx is suitable for use in a metalens targeting a λ>600 nm bandwidth.

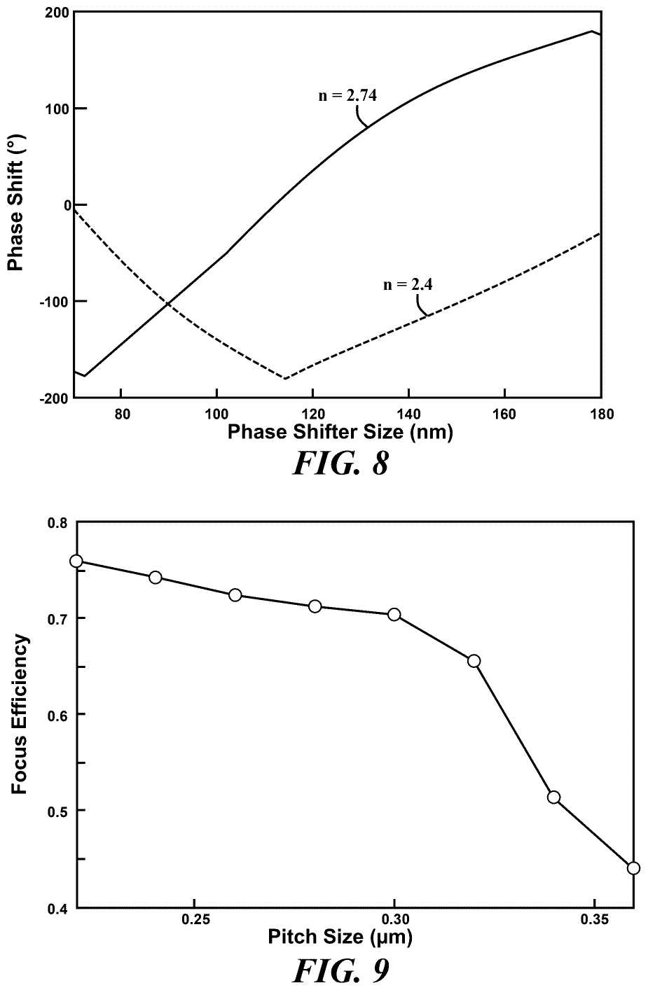

It has now been found that Si-rich SiNx can shrink the pitch size down to 220 nm under 685 nm light. FIG. 8 illustrates a Rigorous Couple-Wave Analysis (RCWA) simulation of phase distribution for phase shifters 16 having a pitch P=220 nm, a thickness T=600 nm, and a feature size L=60 nm (aspect ratio=10) at two different refractive indices, n=2.74 and n=2.4. As illustrated, a lens material 14 having a refractive index n=2.74 can achieve continuous full 2π phase coverage under the nanofabrication-limited feature size of L=60 nm, while material of refractive index n=2.4 (e.g., TiO₂) can only cover half of it (i.e., −π to 0).

To evaluate the effectiveness of minimization of space discretization on focus efficiency, a series of propagation-phase-based metalenses were designed in 2D with a pitch size P in a range from 220 nm to 360 nm. These lenses are designed with a high numerical aperture NA=0.9 under incidence of 685 nm light. The thickness T of the lens material 14 was fixed at 600 nm, and the feature size L was set around 60 nm. A Finite-Difference Time-Domain (FDTD) simulation was performed for each lens under appropriate conditions (i.e., sufficiently small grid size and sufficiently long simulation time). For purposes of the simulation, lens size was fixed at 40 μm to limit the necessary computing resources. As shown in FIG. 9, focus efficiency increases from 44.8% to 75.8% with a decrease in pitch size P from 360 nm to 220 nm.

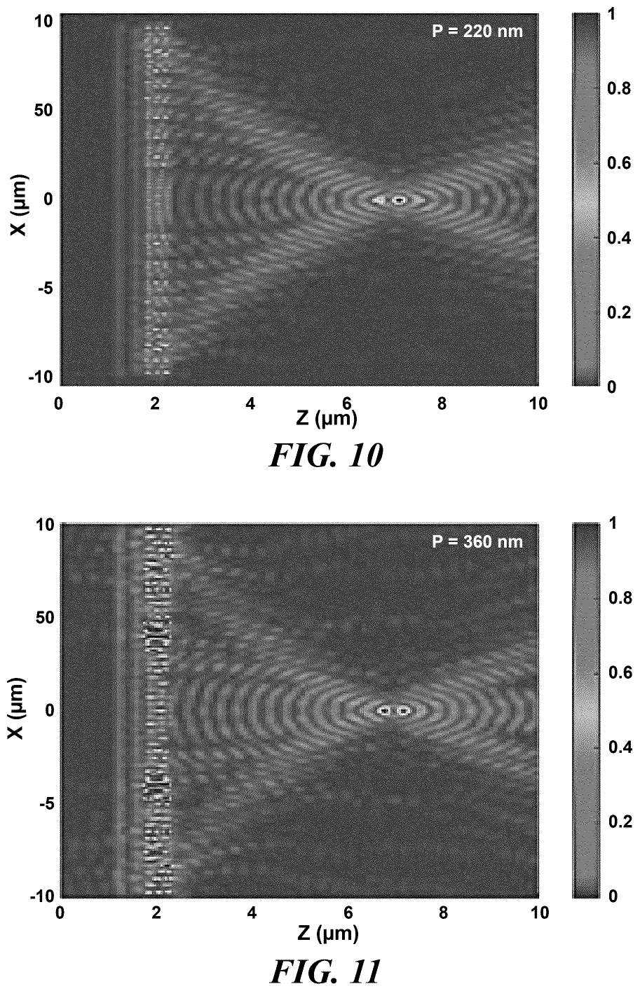

FIGS. 10 and 11 illustrate the field distribution of lenses designed with a 220 nm period and a 360 nm period, respectively. The background intensity is magnified at the same level in order to observe scattered light more clearly. The smaller pitch size P=220 nm in FIG. 10 demonstrates a smooth concentrating profile relative to the larger pitch size P=360 nm of FIG. 11. The lens with the 360 nm pitch size also demonstrates undesirable strong resonance behavior at the lens plane relative to the 220 nm pitched lens. The scattered light outside the focusing profile is notable in the example of FIG. 11 (P=360 nm). This poor focusing performance of the 360 nm pitched lens relative to the 220 nm pitched lens is a result of coarse space discretization. In this case, scattering and undesired resonance become more significant.

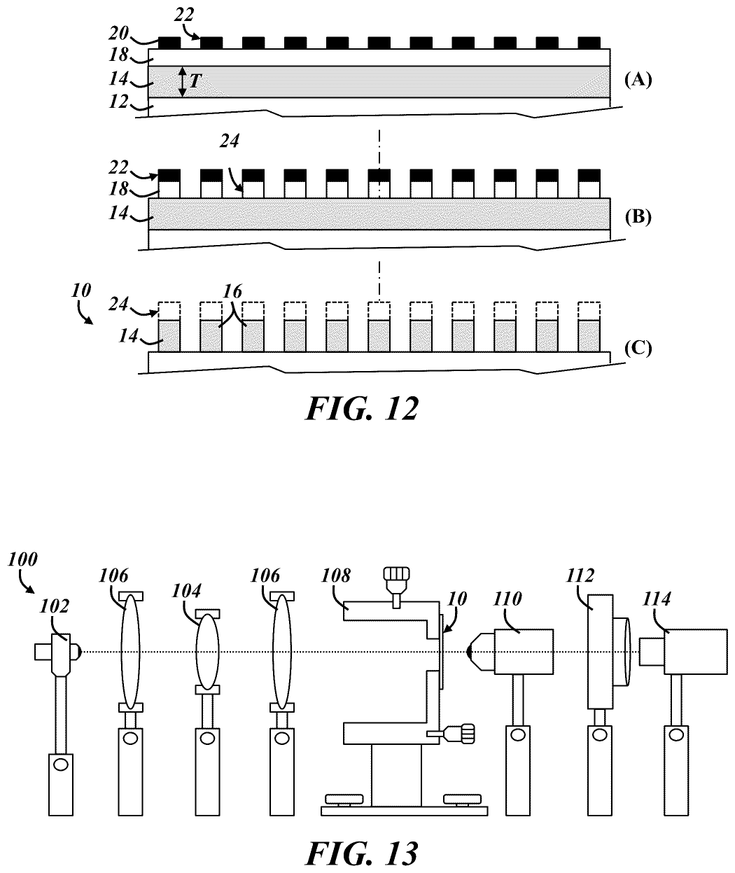

FIG. 12 is a schematic cross-sectional depiction of the fabrication of the metalens 10 of FIG. 3. First, a layer of Si-rich SiNx lens material 14 is deposited on the substrate 12. The substrate 12 may be glass, and the lens material 14 may be deposited via reactive PECVD as described above to tune the refractive index as desired. The refractive index of the lens material 14 is greater than that of Si₃N₄, or n>2.0. In one embodiment, the SiNx material has a refractive index n=2.74 and is deposited with a thickness T=600 nm. A hard mask layer 18 is then deposited on the layer of lens material 14 to later serve as a mask in a two-step etching process. In one embodiment, the hard mask layer 18 is a 300 nm layer of SiO2. A photoresist layer 20 is then deposited over the hard mask layer 18. The photoresist layer 20 may be spin-coated at a thickness of 200 nm. E-beam lithography is then used to write the desired 2D metalens pattern on the photoresist layer 20, thereby creating a photoresist mask 22 in the desired lens pattern when developed, as shown in FIG. 12(A).

The lens pattern is then transferred into the hard mask layer 18 by reactive ion etching (RIE) to form the hard SiO2 mask 24, as shown in FIG. 12(B). The photoresist mask 22 can then be removed via O2 plasma stripping, for example, prior to a second etching step.

The lens pattern is finally transferred into the lens material 14 via the second etching step, as shown in FIG. 12(C). This step may also be performed via RIE with selectivity of the etchant adjusted to prefer the SiNx layer 14. For example, the selectivity of SiNx/SiO₂ may be around 2.0 with the application of 20% SF₆ concentration under 5-20 mT during reactive ion etching, thus forming the desired pattern of phase shifters 16 in the lens material 14. The metalens 10 is thus formed after removal of the residual SiO₂ mask 24.

The SiO2 hard mask 24 was used in this case because there is no E-beam photoresist available at 200 nm thickness to provide enough selectivity versus SiNx to achieve direct RIE to a 600 nm depth, while the thickness of E-beam resist is limited by the feature size around 60 nm.

FIG. 13 is a schematic view of a laser-based optical system 100 for characterizing the resulting metalens 10. The system includes a diode laser 102, a quarter waveplate 104, linear polarizers 106, a 3-axis motion mount 108 supporting the metalens 10, a 50× objective lens 110, a tube lens 112, and a camera 114.

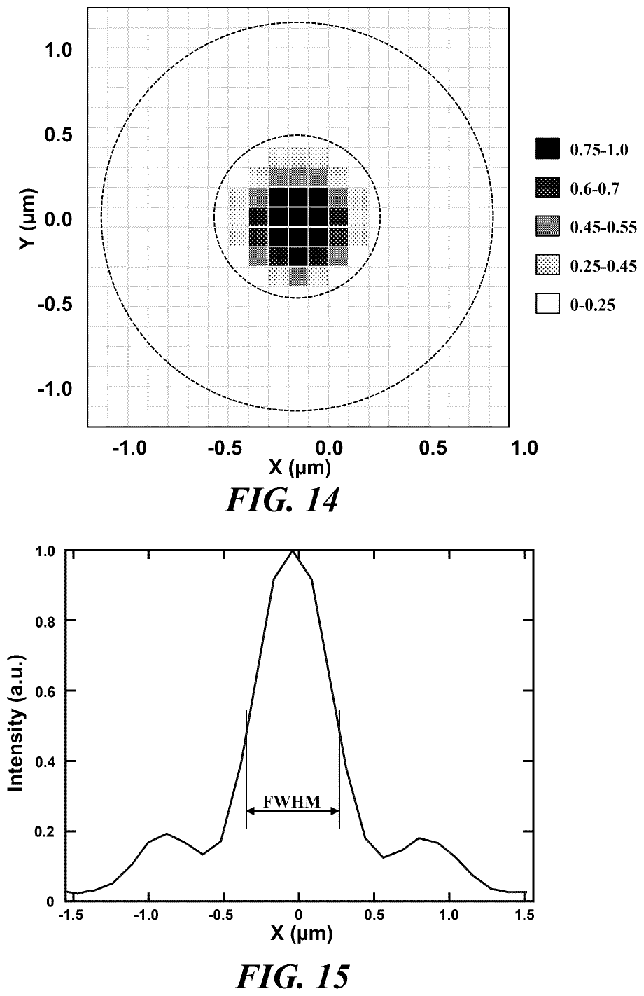

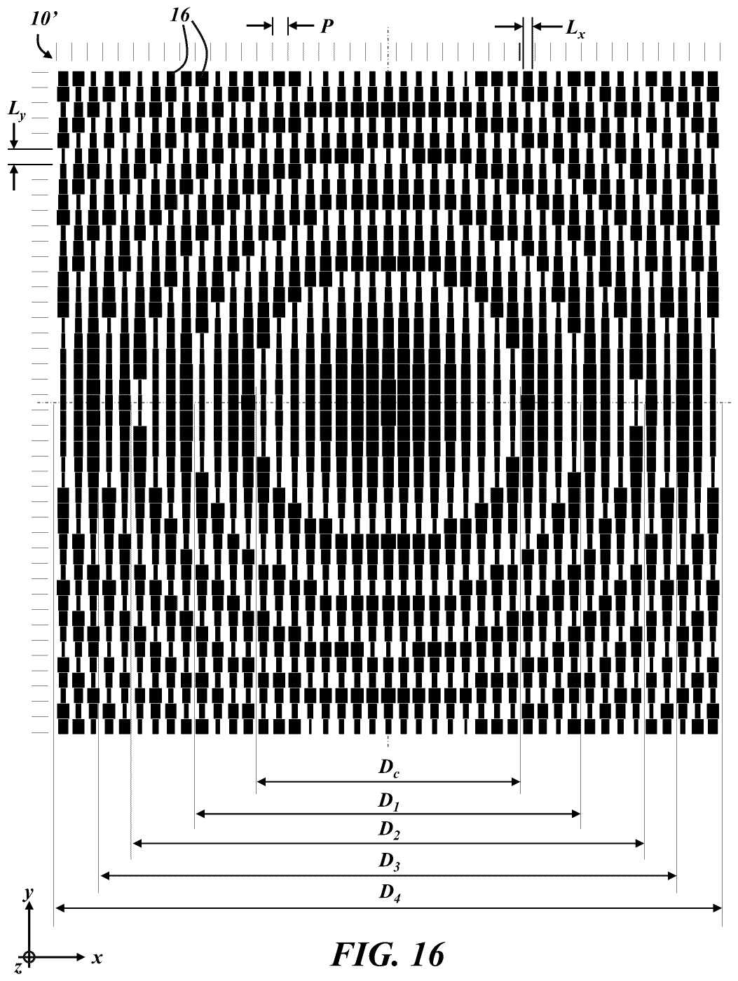

FIG. 14 illustrates the characterized field distribution at the plane of focus, and FIG. 15 illustrates a focus profile plot for the metalens. The black and white patterns in FIG. 14 are approximated from the original color image for purposes of this disclosure. An airy disk can be observed in the original image and is shown in approximation between the dashed lines of FIG. 14. The presence of the airy disc indicates good focus behavior.

With reference to FIG. 15, the measured focus efficiency is around 42% with diffraction-limited FWHM of 702 nm. While the 3D FDTD simulation of this lens, discussed above, indicates a much higher focus efficiency of 79%, the difference between the simulation and actual characterization is mainly caused by the limitation of characterization system 100 in two aspects. First, the 50× objective lens 110 (Olympus, LMPLFLN 50×) has a numerical aperture of NA=0.5, which is considerably lower than that of the metalens (NA=0.65). As a result, the characterization system is not able to catch the peak intensity of diffraction-limited focus. Second, the resolution of the motion system (Thorlabs, MT3A) is 0.5 μm, which is similar to the size of the diffraction limited focus (532 nm). As a result, capturing the exact focal plane is extremely challenging.

FIG. 16 is a plan view of a metalens 10′ configured to achieve a linear polarization distinguishing effect. The illustrated pattern of phase shifters 16 is highly sensitive to the variation of linear polarization. In this example, the lens plane is discretized into a finite number of square periods in two perpendicular directions x, y, as opposed to the annular or ring-shaped periods in the example of FIG. 3. Incident light is intended to be in the z-direction, perpendicular to both of the x- and y-directions. The size of the period P may be sufficiently small relative to the target wavelength to minimize diffraction loss. In a specific example, P=280 nm at a target wavelength of 685 nm. The thickness T of each phase shifter 16 is critical for the metalens designed under linear polarized incidence, as the phase utilized is the propagation phase (different from the Pancharatnam-Berry phase), where sufficient T is necessary to achieve 2π coverage. In one embodiment, the thickness T is fixed at 600 nm for all phase shifters 16.

In the illustrated example, each phase shifter 16 has a dimension in the y-direction Ly=P, while the dimension in the x-direction Lx varies—i.e., the fill factor Fy in the y-direction is 100% while the fill factor Fx in the x-direction varies between 10% and 90%. With each period P fully filled in the y-direction, the variation of the effective index in the y-direction is physically reduced. The respective dimensions Lx in the x-direction are varied to acquire the phase shift necessary under electric field at x-direction (Ex) polarization.

The areal fill factor of each period is FA=LxLy/P2. In this particular case, where Ly=P is constant, the areal fill factor FA is directly proportional to the fill factor Fx in the x-direction. As is apparent in FIG. 16, the areal fill factor varies with distance from the center of the lens 10, roughly forming a central region and concentric bands within which there is a gradient of fill factors. In the illustrated example, the period at the center of the central region of the lens 10 is filled to the maximum permitted by limitations on nanofabrication feature size. From there, the fill factor gradually decreases with distance from the center of the lens for 8 periods, such that Dc=17P, or 4.76 μm where P=280 nm. Then there is a step increase in fill factor at the start of a first concentric band having a width of 4P and in which there is another decreasing gradient until D1=25P, or 7 μm where P=280 nm. Then there is a step increase in fill factor at the start of a second concentric band having a width of 4P and in which there is another decreasing gradient until D2=33P, or 9.24 μm where P=280 nm. Then there is a step increase in fill factor at the start of a third concentric band having a width of 2P and in which there is another decreasing gradient until D3=37P, or 10.36 μm where P=280 nm. Then there is a step increase in fill factor at the start of a fourth concentric band having a width of 3P and in which there is another decreasing gradient until D4=43P, or 11.76 μm where P=280 nm.

The specific numbers of periods in each gradient band listed here are along the x- and y-axis. At non-orthogonal angles from center, the number of periods in each gradient band varies due to diagonal dimensions of the periods being larger than the orthogonal dimensions. This example is non-limiting, as there may be other phase shifter arrangements that provide full 2π phase coverage.

The phase shifter material may be Si-rich silicon nitride as described above with a refractive index n>2.5 (e.g., n=2.74) and an extinction coefficient k=0 at the target wavelength (e.g., 685 nm). The high-refractive index SiNx can provide a sufficient propagation phase shift within a small period P. As noted above, Si-rich SiNx deposition can be achieved via plasma enhanced chemical vapor deposition (PECVD), which is faster and more cost efficient than the atomic layer deposition (ALD) process required for a TiO₂ metalens. In a specific embodiment the SiNx lens material 14 is deposited on a glass wafer substrate 12 with a refractive index n=1.46 and a thickness of 500 μm. The optical properties of the glass wafer and SiNx films are measured through a Woollam M-2000 ellipsometer. By matching the phase requirement, a polarization distinguishing lens is achieved.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A subwavelength metalens comprising a layer of silicon-rich silicon nitride in which a ratio of silicon to nitrogen is greater than 0.75.

2. The metalens of claim 1, wherein the silicon-rich silicon nitride has a refractive index in a range from 2.0 to 3.2 at a visible wavelength.

3. The metalens of claim 1, wherein the silicon-rich silicon nitride has a refractive index in a range from 2.1 to 2.8 at a visible wavelength.

4. The metalens of claim 1, wherein the silicon-rich silicon nitride has a refractive index in a range from 2.7 to 2.8 at a visible wavelength.

5. The metalens of claim 1, wherein the silicon-rich silicon nitride has a refractive index of 2.74 at a 685 nm wavelength.

6. The metalens of claim 1, wherein the layer of silicon-rich silicon nitride includes a plurality of discrete phase shifters each arranged in a discrete period of the layer.

7. The metalens of claim 6, wherein each period has a planar dimension less than 350 nm.

8. The metalens of claim 6, wherein each period has a planar dimension of 220 nm.

9. The metalens of claim 6, wherein each phase shifter has a planar dimension less than 220 nm.

10. The metalens of claim 6, wherein at least one phase shifter has a planar dimension of 60 nm.

11. The metalens of claim 10, wherein at least one other phase shifter has a planar dimension greater than 60 nm and less than 220 nm.

12. The metalens of claim 6, wherein the phase shifters are in the form of concentric rings.

13. The metalens of claim 6, wherein the phase shifters are arranged in an orthogonal array of periods.

14. The metalens of claim 6, wherein a fill factor for each period is 100% in a first direction and varies in a range from 10% to 90% is a second direction that is perpendicular to the first direction.

15. The metalens of claim 6, wherein the phase shifters are arranged in concentric bands in which a fill factor of the periods within the bands decreases with distance from a center of the metalens.

16. The metalens of claim 1, wherein the layer of silicon-rich silicon nitride has a thickness of 600 nm or less and the lens has full 2π phase coverage with a period less than 350 nm.

17. The metalens of claim 1, wherein the metalens is substantially free from titanium oxide and gallium nitride.

18. A method of making the metalens of claim 1, comprising plasma-enhanced chemical vapor deposition of the silicon-rich silicon nitride onto a substrate.

19. The method of claim 15, wherein the refractive index of the silicon-rich silicon nitride is a continuous function of a ratio of silane and ammonium in a gas mixture introduced into a deposition chamber.

20. A subwavelength metalens, comprising:
an optically transparent substrate; and
a plurality of discrete phase shifters disposed over the substrate, each phase shifter being located within a respective discrete period of an array of periods defined over the substrate,
wherein:
each period has a planar dimension less than or equal to 280 nm,
each phase shifter has a dimension in a first direction equal to the planar dimension of the respective period such that the phase shifters are continuous in the first direction,
each phase shifter has a dimension in a second direction perpendicular to the first direction in a range from 10% to 90% of the planar dimension of the respective period such that a fill factor of the plurality of periods varies as a function of distance from a center of the metalens in the second direction, and
the phase shifters are formed as a layer of silicon-rich silicon nitride having a ratio of silicon to nitrogen greater than 0.75.
